(19) United States
(12) Patent Application Publication
(10) Pub. No.: US 2005/0169701 A1
(43) Pub. Date: Aug. 4, 2005

(54) Reinforcing bar splice and method

(76) Inventors: Antonius M. Kies, Oisterwijk (NL); Colleen M. Kerkay, Olmsted Township, OH (US)

Correspondence Address: Jonathan A. Platt;Renner, Otto, Boisseller & Sklar, LLP, Nineteenth Floor, 1621 Euclid Avenue, Cleveland, OH, 44115, US

(21) Appl. No.: 11/014,917

(22) Filed: Dec. 17, 2004

Related U.S. Application Data
(60) Provisional application No. 60/531,367, filed on Dec. 18, 2003.

(51) Int. Cl. F16B 7/00

(52) U.S. Cl. 403/293

(57) ABSTRACT

A splice for joining ends of reinforcing bars includes a sleeve having internal threads, and a clamp for pushing the reinforcing bars and the threads together, causing the threads to bite into the bars. The clamp may include threaded couplers that pass through holes in the sleeve, allowing the threaded couplers to themselves bite into or otherwise engage the ends of the reinforcing bars. The splice may have such internal threads at both ends, or alternatively, may be internally threaded on one of its ends, and may use another type of coupling on the opposite end.

This application claims priority under 35 USC 119(e) from U.S. Provisional Patent Application No. 60/531,367, filed Dec. 18, 2004, which is herein incorporated by reference in its entirety.

### BACKGROUND OF THE INVENTION

1. Field of the Invention

The invention is related to the field of devices and methods for coupling reinforcing bars.

2. Description of the Related Art

In steel reinforced concrete construction, there are generally three types of splices or connections; namely lap splices; mechanical splices; and welding. Probably the most common is the lap splice where two bar ends are lapped side-by-side and wire tied together. The bar ends are of course axially offset which creates design problems, and eccentric loading whether compressive or tensile from bar-to-bar. Welding is suitable for some bar steels but not for others and the heat may actually weaken some bars. Done correctly, it requires great skill and is expensive. Mechanical splices normally require a bar end preparation or treatment such as threading, upsetting or both. They also may require careful torquing.

Improvements are continually being sought in mechanical splices and splicing methods, for instance to improve performance, cost, and/or ease of installation.

### SUMMARY OF THE INVENTION

According to an aspect of the invention, a sleeve has an internally threaded portion for biting into a pair of reinforcing bars or other cylindrical objects to be connected.

According to another aspect of the invention, a splice includes an internally threaded sleeve, and a clamp that caused threads of the sleeve to bite into one or more cylindrical objects.

According to yet another aspect of the invention, a sleeve for use in coupling cylindrical objects includes an internal offset thread.

According to still another aspect of the invention, a reinforcing bar splice for joining a pair of generally axially-aligned reinforcing bars, includes a sleeve including a pair of sleeve ends having respective openings each for receiving a bar end of one of the reinforcing bars; and a clamp. One of the sleeve ends has an internally threaded surface. The clamp is operatively configured to relatively press one of the reinforcing bars and the internally threaded surface together.

According to a further aspect of the invention, a method of coupling together a pair of axially-aligned reinforcing bars, includes the steps of: placing bar ends of the bars in a sleeve having an internally threaded surface; and pressing the bar ends and the internally threaded surface together.

According to a still further aspect of the invention, a reinforcing bar connection includes a pair of generally axially-aligned reinforcing bars; and a splice for joining a pair of generally axially-aligned reinforcing bars. The splice includes: a sleeve including a pair of sleeve ends having respective openings each for receiving a bar end of one of the reinforcing bars; and a clamp. One of the sleeve ends has an internally threaded surface. The clamp is operatively configured to relatively press one of the reinforcing bars and the internally threaded surface together.

According to another aspect of the invention, a reinforcing bar connection includes an internally-threaded sleeve, and a clamp that causes the threads of the sleeve to bite into ends of reinforcing bars, such as deformations on the reinforcing bars.

According to still another aspect of the invention, a reinforcing bar splice for joining a pair of generally axially-aligned reinforcing bars, includes: a sleeve including a pair of sleeve ends having respective openings each for receiving a bar end of one of the reinforcing bars, wherein at least one of the sleeve ends has an internally threaded surface; and threaded couplers that engage threaded holes in the sleeve, to relatively press one of the bar ends and the internally threaded surface together. The threaded holes are arrayed in a zigzag pattern, with some of the threaded holes being circumferentially offset from other of the threaded holes.

According to yet another aspect of the invention, a reinforcing bar splice for joining a pair of generally axially-aligned reinforcing bars, includes: a sleeve including a pair of sleeve ends having respective openings each for receiving a bar end of one of the reinforcing bars; and a plurality of threaded couplers that pass through respective smooth holes in the sleeve and engage respective threaded holes in the sleeve. At least one of the sleeve ends has an internally threaded surface. The sleeve is configured such that engaging the threaded couplers in the threaded holes presses together the internally threaded surface and at least one of the bar ends.

According to a further aspect of the invention, a reinforcing bar splice for joining a pair of generally axially-aligned reinforcing bars, includes: a sleeve including a pair of sleeve ends having respective openings each for receiving a bar end of one of the reinforcing bars; a plurality of threaded couplers; and an insert placed at least partially within the sleeve. At least one of the sleeve ends has an internally threaded surface. The threaded couplers engage the insert placed at least partially within the sleeve, thereby pressing the insert against at least one of the bar ends, and thereby pressing the at least one of the bar ends against the internally threaded surface.

To the accomplishment of the foregoing and related ends, the invention comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF DRAWINGS

In the annexed drawings, which are not necessarily to scale:

FIG. 1 is an oblique view of a splice in accordance with the present invention;

FIG. 2 is an oblique view showing the splice of FIG. 1 used to couple together a pair of reinforcing bars;

FIG. 3 is an end view of the splice of FIG. 2;

FIG. 4A is a side cross-sectional view of the splice of FIG. 2;

FIG. 4B is a side cross-sectional view of another embodiment of the splice of FIG. 2;

FIG. 5 is a magnified view of part of the splice of FIG. 4, illustrating the biting engagement of a threaded coupler to a reinforcing bar;

FIG. 6 is an end view showing an alternate embodiment sleeve for use with the splice of FIG. 1;

FIG. 7 is a side view used for illustrating installation of the splice of FIG. 1;

FIG. 8 is an oblique view of an alternate embodiment splice in accordance with the present invention;

FIG. 9 is an oblique view of another alternate embodiment splice in accordance with the present invention;

FIG. 10 is an end view of the splice of FIG. 9;

FIG. 11 is a top view of the splice of FIG. 9;

FIG. 12 is an exploded view showing still another embodiment splice in accordance with the present invention, utilized for coupling to a reinforcing bar having a tapered threaded end;

FIG. 13 is a side cross-sectional view of the splice of FIG. 12;

FIG. 14 is an oblique view of a further embodiment of a splice in accordance with the present invention, coupling together a pair of reinforcing bars;

FIG. 15 is an oblique view showing the sleeve of the splice of FIG. 14;

FIG. 16 is an end view of the splice of FIG. 14;

FIG. 17 is an oblique view showing a still further embodiment of a bar splice in accordance with the present invention;

FIG. 18 is an oblique view of the sleeve of the splice of FIG. 17;

FIG. 19 is an end view of the splice of FIG. 17;

FIG. 20 is an oblique view of still another embodiment of a bar splice in accordance with the present invention; and

FIG. 21 is an exploded view showing details of some parts of the bar splice of FIG. 20.

### DETAILED DESCRIPTION

A splice for joining ends of reinforcing bars includes a sleeve having internal threads, and a clamp for pushing the reinforcing bars and the threads together, causing the threads to bite into the bars. The clamp may include threaded couplers that pass through holes in the sleeve, allowing the threaded couplers to themselves bite into or otherwise engage the ends of the reinforcing bars. The splice may have such internal threads at both ends, or alternatively, may be internally threaded on one of its ends, and may use another type of coupling on the opposite end.

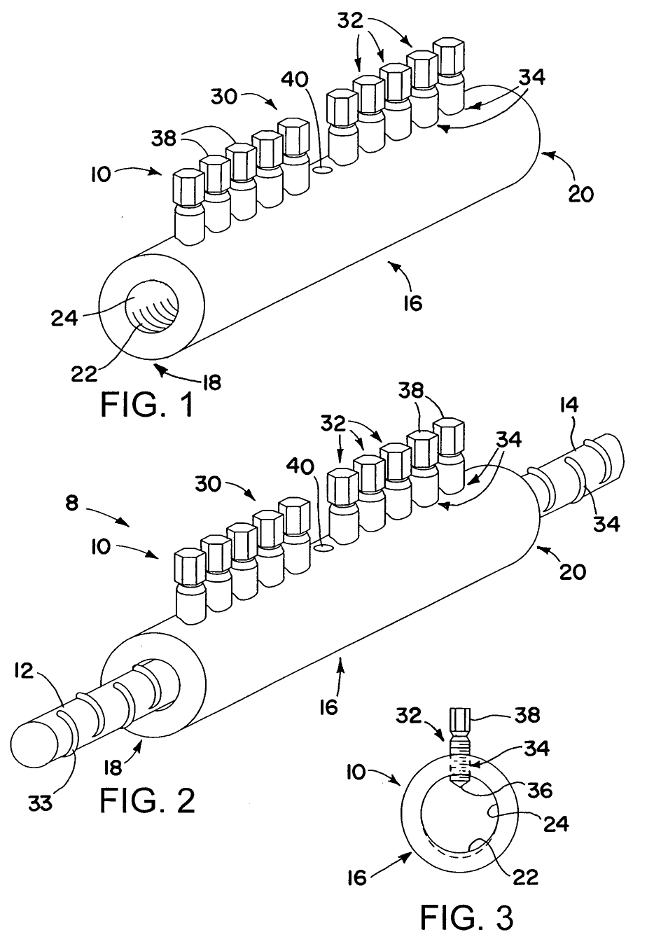

Referring initially to FIGS. 1-5, a reinforcing bar connection 8 includes a splice 10, for splicing together a pair of reinforcing bars 12 and 14 or other cylindrical objects to be coupled. The splice 10 includes a sleeve 16. The sleeve 16 has openings in first and second sleeve ends 18 and 20 for receiving the reinforcing bars 12 and 14, respectively. The openings may be a single hole passing through the center of the sleeve 16. The sleeve 16 has threads 22 along at least part of an inner surface 24.

A clamp 30 is used to press the reinforcing bars 12 and 14 into the threads 22, thereby causing the threads 22 to bite into and secure the reinforcing bars 12 and 14. The clamp 30 may have any of a variety of forms and/or configurations, some of which are discussed below. According to the embodiment shown in FIGS. 1-5, the clamp 30 includes a row of threaded couplers 32, such as set screws, that are placed into a longitudinal (axial) line of threaded radial holes 34 in the sleeve 16. As the threaded couplers 32 are screwed into the sleeve 16, they press into the reinforcing bars 12 and 14 already inserted into the ends 18 and 20 of the sleeve 16.

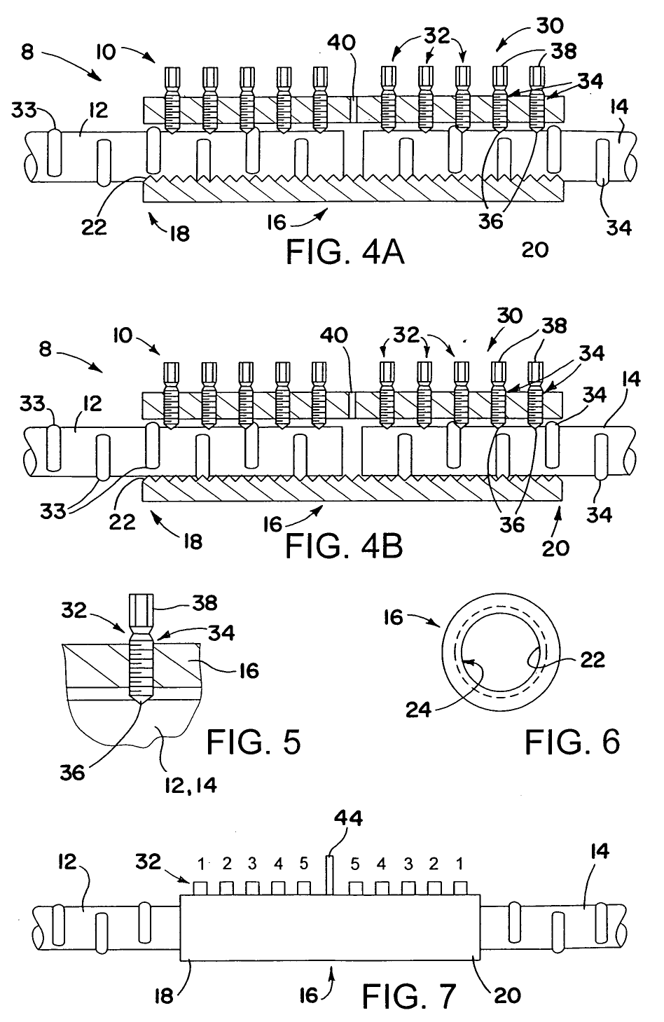

The threaded couplers 32 drive the reinforcing bars 12 and 14 onto the threads 22 thereby causing the threads 22 to bite into the ends of the reinforcing bars 12 and 14, as is best shown in FIGS. 4A and 4B. More specifically, as illustrated in FIG. 4B, the threads 22 may bite into and at least partially penetrate respective sets of deformations 33 and 34 of the reinforcing bars 12 and 14. It will be appreciated that the reinforcing bars 12 and 14 discussed herein with regard to the various embodiments of the splice 10, may have any of a variety of deformations or protrusions thereupon, that may be engaged by threads that bite into, or at least penetrate, the deformations. Although these deformations are only illustrated in some of the figures, it will be appreciated that similar reinforcing bar deformations may be employed with other of the reinforcing bars 12 and 14 shown in figures, and discussed herein.

As illustrated in FIG. 5, the threaded couplers 32 may each have one or more biting tips 36 configured to bite into the reinforcing bars 12 and 14, to provide further securement for keeping the reinforcing bars 12 and 14 within the splice 10. The biting tips 36 may be suitable pointed or ridged portions of the threaded couplers 32.

In addition, the threaded couplers 32 may have respective heads 38 that are configured to be sheared off once a desired torque is reached. The use of the shear heads 38 helps prevent over- or under-torquing of the threaded couplers 32, assuring that a proper amount of torque is used in installing the threaded couplers 32. This allows achievement of a repeatable level of loading of the reinforcing bars 12 and 14 against the threads 22. In addition, using the shear heads 38 results in a lower profile for the completed splice 10.

It will be appreciated that the threaded couplers 32 may be any of a wide variety of types of suitable couplers. For example, instead of having a hex head, the couplers 32 alternatively may have a hexagon-shape depression for receiving an Allen wrench for tightening.

As best illustrated in FIG. 3, the threads 22 may be offset threads that extend only over a portion of the inner surface 24 of the sleeve 16. The threads 22 may be centered opposite the threaded holes 34 through which the threaded couplers 32 pass. An example of the thread profile for the tube is a 1⅜-8 UN thread, which provides a substantially symmetric tooth profile, with the threads being approximately 1.6 mm (0.063 inches) high. For a 32 mm (1.25 inch) tube inner diameter, the threads may be about 1.5 mm (0.06 inches) offset from the center of the sleeve 16. The circumferential extent of the threads may be about 180 degrees, although the extent of the threads may be greater or lesser.

As an alternative to partial threading, the sleeve 16 may be fully threaded as illustrated in FIG. 6, with the threads 22 extending symmetrically or asymmetrically all the way around the inner surface 24 of the sleeve 16. However, having the sleeve 16 only partially threaded may offer several advantages over fully threading the sleeve 16. Partial threading aids in avoiding burrs when placing the threaded holes 34 in the sleeve 16. In addition, partial threading may result in adding strength of the sleeve 16, and may reduce fabrication time and/or costs.

The threads 22 may be a single continuous threaded portion across the length of the sleeve 16. Alternatively, the threads 22 may be two or more separate threaded sections.

The sleeve 16 may be made of a suitable steel, for example 4130 or 4140 steel. The area of the sleeve 16 that is threaded with the threads 22 may be hardened, for example to 42 HRC or to 40-44 HRC.

The splice 10 illustrated in FIG. 1 has been tested, and bar break has been achieved, utilizing such a splice in a connection joining together reinforcing bars. This means that the splice 10 may be stronger than the reinforcing bars 12 and 14 that it couples together, such that under loading of the connection the bars themselves will fail before the splice does.

The sleeve 16 may have a wall thickness that is about one-half of the diameter of the reinforcing bars 12 and 14. The length of the sleeve 16 may be about 12 times the diameter of the reinforcing bars 12 and 14. It will be appreciated that these figures are only examples of a single specific embodiment, and that the sleeve 16 may have other lengths and/or wall thickness.

The sleeve 16 has a central hole 40 therein. The central hole 40 allows for insertion of a pin, such as a cotter pin or a 3/16-inch quick release pin in the center of the sleeve 16, to act as a stop during insertion of the reinforcing bars 12 and 14. Inserting a pin in the central hole 40 facilitates proper placement of the reinforcing bars 12 and 14, ensuring that each of the bars is inserted in roughly half of the sleeve 16. Thus, over- or under-insertion of the reinforcing bars 12 and 14 may be prevented.

With reference now to FIG. 7, the installation of the splice 10 is discussed. A pin 44 may be placed in the central hole 40 of the sleeve 16, as discussed above, to control proper insertion of the reinforcing bars 12 and 14. The reinforcing bars 12 and 14 are then placed within the ends 18 and 20 of the sleeve 16. This may be done by either placing one or both of the bars into the sleeve 16, or by sliding the sleeve 16 onto one of the reinforcing bars 12 and 14, and placing the other of the reinforcing bars 12 and 14 into the sleeve 16, either before or after the sliding.

After the bars 12 and 14 are placed in the ends 18 and 20 of the sleeve 16, the threaded couplers 32 are inserted into the threaded holes 34, and are tightened so as to engage the reinforcing bars 12 and 14, and press the bars 12 and 14 onto and into the threads 22. All of the threaded couplers 32 engaging one of the reinforcing bars 12 and 14 may be tightened before any of the threaded couplers 32 engaging the other of the reinforcing bars are tightened. With reference to FIG. 7, the reinforcing bars on each of the sides are numbered with reference numbers 1-5, with 1 indicating the outermost of the threaded couplers 32, and 5 indicating the innermost (closest to the center of the sleeve 16) of the threaded couplers 32. One order of tightening the couplers is 2-4-1-3-5 on each side of the splice 10, with (as indicated above) the couplers 28 on one of the sides all being tightened before any of the threaded couplers 28 on the other of the sides being tightened. It will be appreciated that other orders and/or ways of tightening the threaded couplers 32 may be employed.

In an example embodiment the threaded couplers 32 are set screws with pointed tips. The heads 38 of the set screws are configured to shear off at a torque of between about 237-271 N-m (175-200 ft-lbs). The set screws may be tightened to at least about 136 N-m (100 ft-lbs).

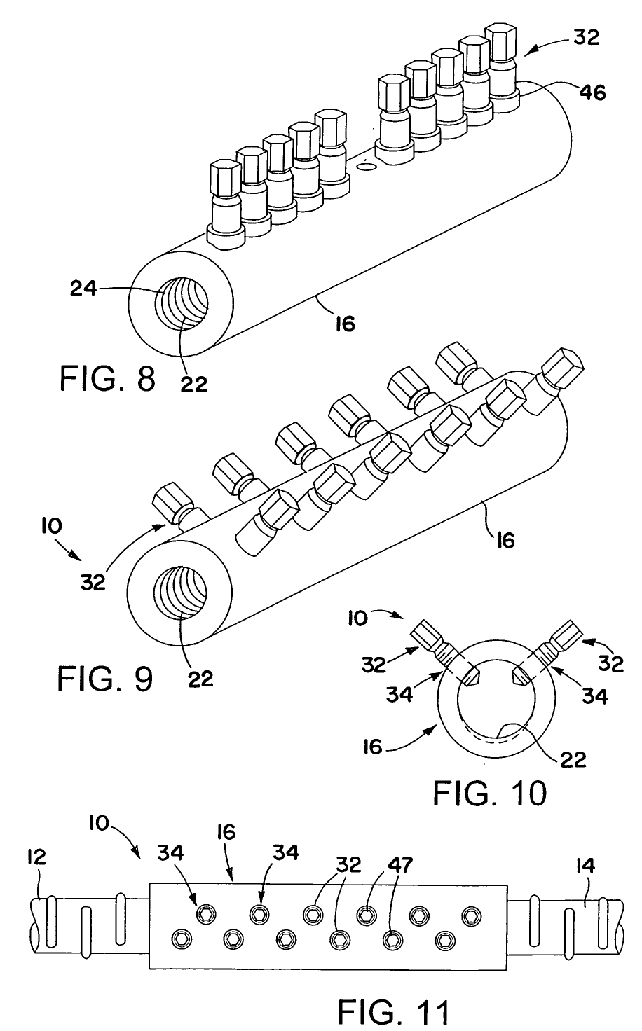

FIG. 8 shows an alternate embodiment of the sleeve 16 that includes protrusions 46 around the threaded holes 34. The protrusions 46 provide additional strength to the sleeve 16 in the area around the threaded holes 34.

FIGS. 9-11 show an alternate embodiment of the splice 10, wherein the threaded holes 34 in the sleeve 16 are not all in a single longitudinal line, but are rather in a zigzag configuration. Thus, the threaded couplers 32 engage the reinforcing bars 12 and 14 along two lines circumferentially offset from one another, rather than along a single line. The zigzag configuration has alternating of the threaded radial holes 34 in the longitudinal direction along the sleeve 16. This results in having the threaded couplers 32 at different circumferential locations along the sleeve 16. The use of the zigzag configuration shown in FIGS. 9-11 may allow a reduction in the overall length of the sleeve 16, while still maintaining gripping of the reinforcing bars 12 and 14 and sufficient force for allowing the threads 22 to bite into the reinforcing bars 12 and 14.

The threaded couplers 32 may have a hexagonal recess 47, for receiving an Allen wrench or hex key. It will be appreciated that the recess 47 may alternatively have another suitable shape for receiving a correspondingly-shaped wrench or key.

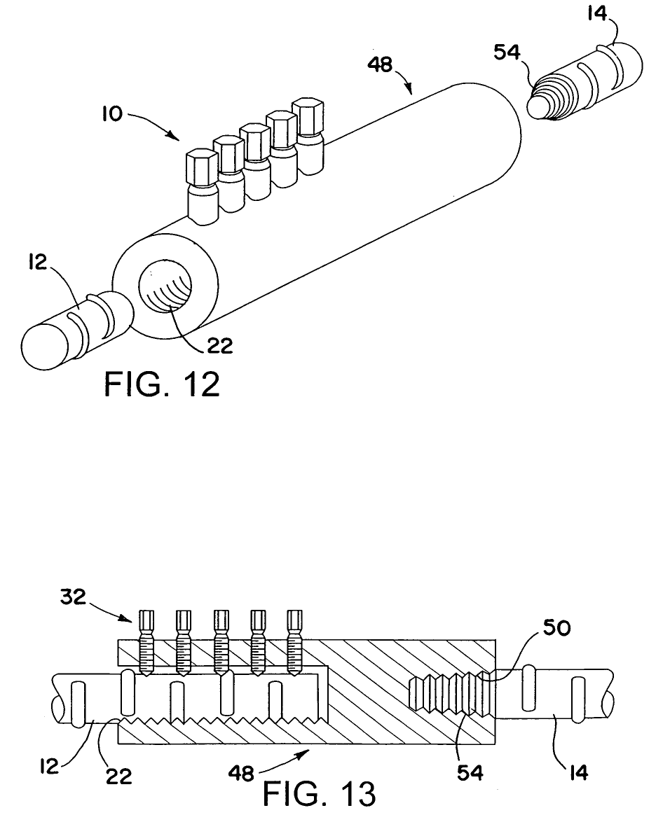

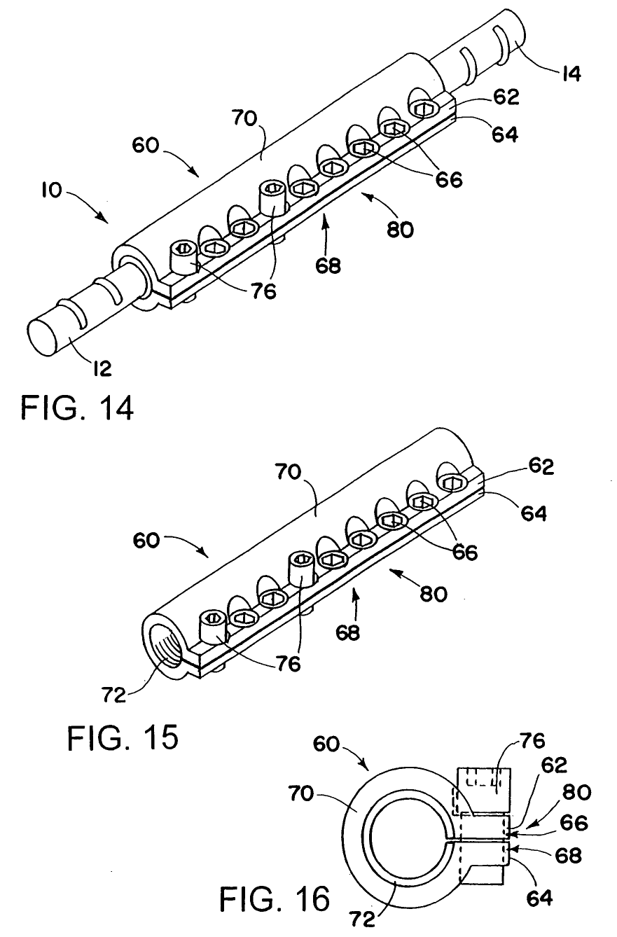

FIGS. 12 and 13 show another embodiment of the splice 10, with a sleeve 48 having an internal tapered thread 50 at the second end 20. The internal tapered thread 50 engages a corresponding external tapered thread 54 on the reinforcing bar 14. The first end 18 of the splice 10 is the same as in the other splices described above, with threaded couplers 32 and internal threads 22 that bite into the reinforcing bar 12. The splice 10 shown in FIGS. 12 and 14 is suitable for engaging reinforcing bars with tapered, externally threaded ends, such as reinforcing bars tapered to utilize LENTON splicing systems sold by Erico, Inc., of Solon, Ohio, USA.

FIGS. 14-16 show another embodiment of the splice 10, the splice utilizing an internally-threaded flanged sleeve 60. The sleeve 60 has a generally C-shape cross section, with opposed flanges 62 and 64 having corresponding arrays of holes 66 and 68 respectively. The sleeve 60 has a C-shape rounded portion 70, with the flanges 62 and 64 connecting to the rounded portion 70 on the open ends of the rounded portion 70. The rounded portion 70 includes internal threads 72 for engaging and biting into reinforcing bar ends 12 and 14. The threads 72 may be similar to the threads 22 (FIGS. 3 and 6) discussed above.

The holes 66 in the flange 62 may be smooth holes, and the holes 68 in the flange 64 may be internally-threaded holes. Threaded couplers 76 pass through the holes 66 and are threaded into the threaded holes 68. The threaded coupler 76 may be tightened to pull the flanges 62 and 64 closer together, thereby constricting the rounded portion 70 and causing the threads 72 to engage and bite into the ends of the reinforcing bars 12 and 14. Thus, the structure of the sleeve 60 and the threaded coupler 76 combine to constitute a clamp 80 for causing the threads 72 to bite into the ends of the reinforcing bars 12 and 14. Thus, the splice 10 is engaged on the reinforcing bars 12 and 14.

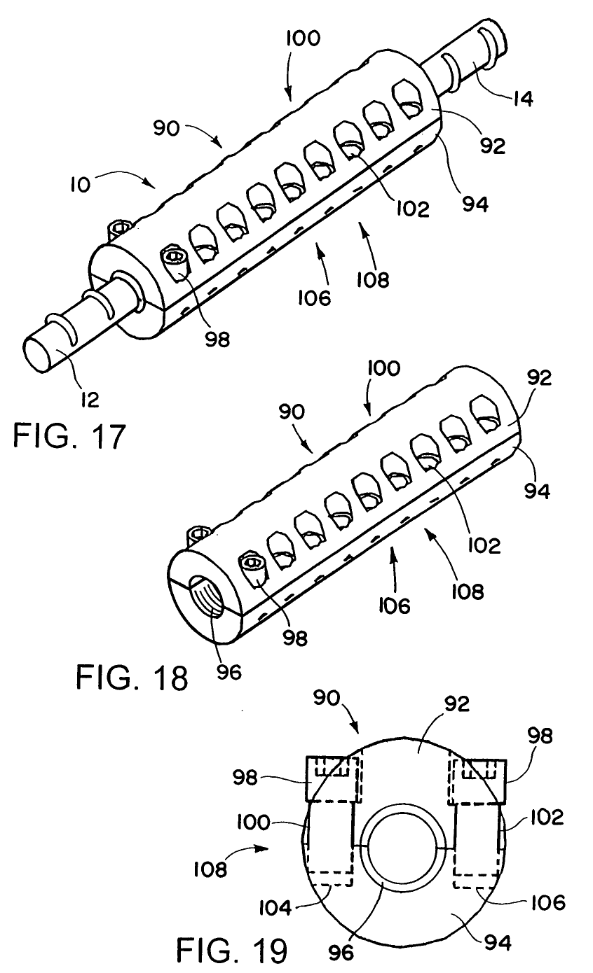

FIGS. 17-19 illustrate yet another embodiment of the splice 10 for coupling the reinforcing bars 12 and 14. The splice 10 shown in FIGS. 17-19 utilizes a sleeve 90 having a pair of sleeve portions 92 and 94, each of the sleeve portions 92 and 94 having internal threads 96. Threaded couplers 98 pass through rows of holes 100 and 102 on opposite sides of the sleeve portion 92 and engage threads in corresponding rows of holes 104 and 106 in the sleeve portion 94. Tightening the threaded couplers 98 within the holes 104 and 106 pulls the sleeve portions 92 and 94 together. This increases pressure of the sleeve portions 92 and 94 against the reinforcing bars 12 and 14, causing the internal threads 96 of the sleeve portions 92 and 94 to bite into and engage the reinforcing bars 12 and 14. Thus the threaded couplers 98 and the holes 100-106 constitute a clamp 108.

It will be appreciated that the threaded couplers 76 and 98 utilized in the embodiments illustrated in FIGS. 13-19 may be bolts or other sorts of couplers not having a sharp point or edge configured for biting.

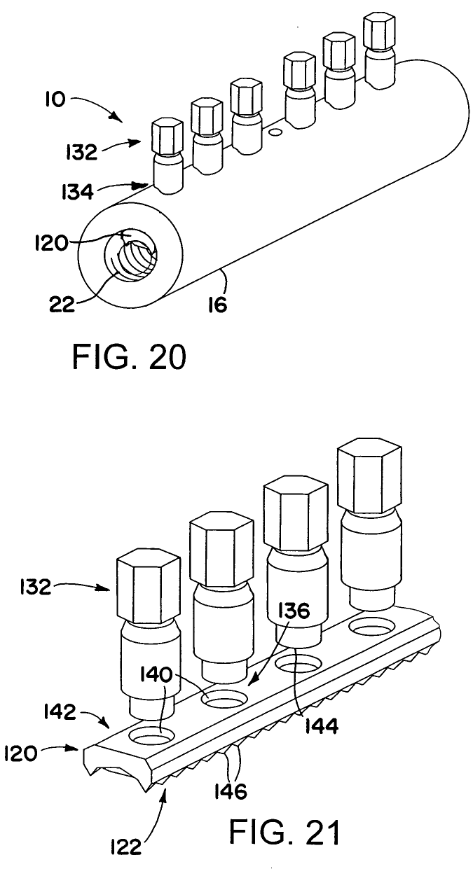

FIGS. 20 and 21 show another embodiment of the bar splice 10. The embodiment shown in FIGS. 20 and 21 includes a partially-threaded sleeve 16, which may be similar to the sleeve 16 described above with regard to other embodiments. The splice 10 includes a toothed insert 120 that has a curved, toothed inner surface 122 that is secured against portions of the reinforcing bars, by the action of threaded couplers 132.

The threaded couplers 132 pass through threaded holes 134 in the sleeve 16, and blunt ends 136 of the couplers engage depressions or recesses 140 in an outer surface 142 of the toothed insert 120. The recesses 140 are placed on the toothed insert 120 at locations corresponding in location to the threaded holes 134. The blunt ends 136 may have a shape that corresponds to the shape of the recesses 140. The blunt ends 136 may have chambers 144 that aid in engagement of the recesses 140, ensuring proper placement of the toothed insert 120 relative to the sleeve 16 and the ends of the reinforcing bars. The blunt ends 136 engage the recesses 140, securing the toothed insert 120 in place, and pressing the ends of the reinforcing bars against threads 22 of the sleeve 16. This pressing drives the threads 22 and radial teeth 146 of the toothed inner surface 122 into the ends of the reinforcing bars, thereby securing the ends of the reinforcing bars in the sleeve.

The splices described herein advantageously provide a low-cost high-performance way of connecting reinforcing bars. The splices are purely mechanical splices, and can be installed easily by slipping the splice onto the bar ends, and tightening the threaded couplers. By having the threads integrated into the sleeve, the splices described may advantageously remove the need for a separate toothed insert.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. A reinforcing bar splice for joining a pair of generally axially-aligned reinforcing bars, the splice comprising:
a sleeve including a pair of sleeve ends having respective openings each for receiving a bar end of one of the reinforcing bars, wherein at least one of the sleeve ends has an internally threaded surface; and
threaded couplers that engage threaded holes in the sleeve, to relatively press one of the bar ends and the internally threaded surface together;
wherein the threaded holes are arrayed in a zigzag pattern, with some of the threaded holes being circumferentially offset from other of the threaded holes.

2. The splice of claim 1, wherein the threaded circumferential portion has an extent of about 180 degrees.

3. The splice of claim 1, wherein the threaded surface extends fully around a circumference of an inner surface of the sleeve.

4. The splice of claim 1, wherein threaded couplers each have one or more biting tips for biting into the bar end.

5. The spice of claim 1, in combination with the reinforcing bars.

6. A reinforcing bar splice for joining a pair of generally axially-aligned reinforcing bars, the splice comprising:
a sleeve including a pair of sleeve ends having respective openings each for receiving a bar end of one of the reinforcing bars; and
a plurality of threaded couplers that pass through respective smooth holes in the sleeve and engage respective threaded holes in the sleeve;
wherein at least one of the sleeve ends has an internally threaded surface; and
wherein the sleeve is configured such that engaging the threaded couplers in the threaded holes presses together the internally threaded surface and at least one of the bar ends.

7. The splice of claim 6,
wherein the sleeve includes a C-shape rounded portion and a pair of opposed flanges at either circumferential end of the rounded portion;
wherein the rounded portion includes the internally threaded surface;
wherein one of the flanges has the smooth holes therein; and
wherein the other of the flanges has the threaded holes therein.

8. The splice of claim 7, wherein at least parts of the threaded couplers pass through cutouts in the rounded portion.

9. The splice of claim 6,
wherein the sleeve includes a pair of separate sleeve portions, at least one of which includes the threaded surface;
wherein one of the sleeve portions has the smooth holes therein; and
wherein the other of the sleeve portions has the threaded holes therein.

10. The splice of claim 9, wherein separate portions are sleeve halves that are divided along a longitudinal plane.

11. The splice of claim 10, wherein the internally threaded surface is only along one of the sleeve halves.

12. The splice of claim 9, wherein for each the holes are in a pair of diametrically opposed lines on opposite sides of internally threaded surface.

13. The spice of claim 6, in combination with the reinforcing bars.

14. A reinforcing bar splice for joining a pair of generally axially-aligned reinforcing bars, the splice comprising:
a sleeve including a pair of sleeve ends having respective openings each for receiving a bar end of one of the reinforcing bars;
a plurality of threaded couplers; and
an insert placed at least partially within the sleeve;
wherein at least one of the sleeve ends has an internally threaded surface; and
wherein the threaded couplers engage the insert placed at least partially within the sleeve, thereby pressing the insert against at least one of the bar ends, and thereby pressing the at least one of the bar ends against the internally threaded surface.

15. The splice of claim 14, wherein the threaded couplers have biting ends that bite into the insert.

16. The splice of claim 14, wherein the threaded couplers engage recesses in the insert.

17. The splice of claim 14, wherein the insert has a toothed inner surface having teeth thereupon, for biting into the bar end.

18. The spice of claim 14, in combination with the reinforcing bars.
